(19) United States
(12) Patent Application Publication
(10) Pub. No.: US 2017/0210662 A1
(43) Pub. Date: Jul. 27, 2017

(54) GLASS LAMINATE HAVING INCREASED STRENGTH

(71) Applicant: SCHOTT AG, Mainz (DE)

(72) Inventors: Fabian WAGNER, Mainz (DE); Andreas ORTNER, Gau-Algesheim (DE)

(73) Assignee: SCHOTT AG, Mainz (DE)

(21) Appl. No.: 15/482,256

(22) Filed: Apr. 7, 2017

Related U.S. Application Data
(63) Continuation of application No. PCT/EP2015/073160, filed on Oct. 7, 2015.

(30) Foreign Application Priority Data
Oct. 7, 2014 (DE) 102014114543.7

(51) Int. Cl. C03B 23/037; C03B 23/047; C03B 23/207; C03B 23/20; C03B 27/012; C03C 3/095; C03C 3/097; C03C 3/112; C03C 3/118; C03C 3/093; C03C 3/087; C03C 3/078; B32B 17/06; C03C 21/00

(52) U.S. Cl. CPC C03B 23/037; B32B 17/06; C03B 23/047; C03B 23/207; C03B 23/20; C03B 27/012; C03C 21/002; C03C 3/097; C03C 3/112; C03C 3/118; C03C 3/093; C03C 3/087; C03C 3/078; C03C 3/095; B32B 2250/03; B32B 2250/40

(57) ABSTRACT

A method for producing a glass article having a compressive stress zone close to the surface by redrawing a preform having a rectangular cross section is provided. The preform includes at least a first and a second glass, wherein both glasses are not connected to each other in the preform in a force-fitting manner. The second glass has a higher thermal expansion coefficient than the first glass and is located in the preform in the interior of the glass tube of the first glass. A glass laminate having increased strength is also provided, which is composed as an at least three-layer composite material of at least two different glasses. The individual layers of the layer composite are connected to each other over the entire area and in a non-positive manner, in particular by melting, and the glass laminate has a thermally stable compressive stress zone in the areas close to the surface of the layer composite and a tensile stress zone in the inner region of the layer composite.

### CROSS REFERENCE TO RELATED APPLICATIONS

This application is a continuation of International Application No. PCT/EP2015/073160 filed Oct. 7, 2015, which claims the benefit under 35 U.S.C. 119 of German Application No. 10 2014 114 543.7 filed Oct. 7, 2014, the entire contents of both of which are incorporated by reference.

### BACKGROUND

1. Field of the Invention

The present invention generally relates to a glass article, in particular to a glass laminate of increased strength, and to a method for producing same. More particularly, the invention relates to the manufacturing of a glass article of increased strength by redrawing of a precursor article.

2. Description of Related Art

The strength of a glass article is an important selection criterion for its use, for example as a display cover for electronic devices. In particular in the case of thin glasses that are used in touch displays, for example, high breaking strength and sufficient scratch resistance has to be ensured.

Glasses of high breaking strength can be obtained by a tempering process, whereby a compressive stress is generated at the surface of the glass and a tensile stress is generated in the interior of the glass.

One possibility for obtaining glasses of increased breaking strength is thermal tempering of the respective sheet glass. For this purpose, this glass is heated to a temperature above the softening point T_{g} and is then quenched. Thereby, the glass is frozen on the surface while the glass interior slowly contracts. Since the glass at the surface is already solid, stresses inside the glass can no longer be compensated. This results in a compressive stress zone in regions of the glass close to the surface and a tensile stress zone in the interior of the glass. However, the method of thermal tempering is limited to glasses with a minimum thickness of about 1 mm, so that this method cannot be employed for thin glasses that have a thickness of less than 1 mm. However, in particular in the touch display sector there is a great demand for very thin toughened glasses.

Such thin glasses can therefore only be toughened by chemical tempering. For this purpose, the glass to be tempered is introduced into a molten salt, for example a molten potassium nitrate, at temperatures in a range from 300° C. to 500° C. Thereby, an ion exchange is caused at the surface or in regions of the glass close to the surface, during which smaller ions of the glass are partially replaced by larger ions of the molten salt. Due to the incorporation of the larger ions into the glass, a compressive stress is established at the surface, which depends on the exchange depth of layer (DOL) of the ions, inter alia. With chemical tempering, a DOL of about 30 to 50 μm can be obtained with processing durations from 4 to 8 hours, the process parameters being dependent on the type and composition of the employed glass. Due to the long processing durations and high temperatures, the process of chemical tempering is a decisive factor under economic aspects. In addition, only alkaline glasses can be chemically tempered, so that not all glasses are suitable for chemical tempering.

A further drawback of thermally or chemically tempered glasses is that the prestress is relieved or offset when the tempered glass is reheated, as a function of the exposure time and the temperature difference to the softening temperature T_{g}. If heated up to the softening temperature T_{g}, the prestress will completely disappear.

Therefore, tempered glasses cannot be reshaped. Further processing with subsequent process steps at high temperatures, for example in coating processes, is also problematic.

Another approach therefore contemplates to provide a glass of increased strength without chemically or thermally tempering the glass. For example, patent application US 2011/0318555 A1 discloses a sheet glass which is configured as an at least three-layered laminate made of two different glasses having different thermal expansion coefficients. The glass which forms the innermost layer of the laminate has a higher coefficient of thermal expansion than the glass which forms the layers above and below the inner layer. Due to the difference in thermal expansion coefficients, a compressive stress zone is created at the surface of the laminate and a tensile stress zone in the interior of the laminate. The laminate is produced by a so-called fusion-draw process. However, the manufacturing process is rather complex since the two glasses are provided as separate molten glasses and are subsequently combined in an apparatus to form a laminate.

Fusion-draw processes however involve the risk of in-situ crystallization of the individual glass layers before they are combined, which may have a detrimental effect on the transparency of the so obtained glass. Moreover, the provision of the starting glasses as molten glasses is complex, so that fusion-draw processes are usually profitable for rather large batches. Another drawback of a fusion-draw process is that the process is susceptible to thickness variations in the so produced glasses. A further problem is that bubbles can easily form in the melt which are only poorly released. Moreover, the fusion-draw process is limited to glasses which exhibit a crystallization speed of less than 0.5 μm/min in the viscosity range from 10⁴ to 10⁵ dPa·s, since otherwise there would be a risk of devitrification.

US 2011/200804 A1 discloses a method for producing a glass laminate of increased strength by redrawing glasses having different thermal expansion coefficients, in which a preform consisting of three different sheet glasses is used.

US 2013/7314940 A1 relates to side emitting glass elements with light guiding elements and scattering elements, which are non-detachably connected to one another on their outer peripheral surfaces. The so connected elements have an envelope of a cladding glass. For manufacturing, first a preform including light guiding elements and scattering elements is used and is inserted into an envelop tube sealed at a lower end. Then, the envelop tube with the preform is heated and drawn, whereby the cladding tube melts and encases the preform. This is intended to provide a side emitting glass element in which the location of lateral light emission can be selectively adjusted. Therefore, the optical properties of the glass components employed are relevant in this case, but not their thermal expansion coefficients.

### SUMMARY

Therefore, an object of the invention is to provide a method for producing a glass article, in particular a sheet glass of increased strength, which in particular has a thermally stable compressive stress zone, which does not exhibit the drawbacks mentioned above, and which permits to process glasses of different compositions. A further object is to provide a corresponding glass article, in particular a corresponding sheet glass of increased strength.

According to the method of the invention, a glass article, in particular a sheet glass, having a compressive stress zone close to the surface is produced by redrawing. The glass article according to the invention is provided as an at least three-layered laminate of two different glasses. In the present context, laminate refers to a composite material which comprises different films or layers which are connected to each other over their entire surface area in non-positive manner. In particular, the individual layers of the laminate are bonded to one another without adhesion promoters.

According to the method of the invention, first a preform is provided which consists of at least two separate components, i.e. components not connected in a force-fitted manner. According to a preferred embodiment, the air located between the individual components of the preform is removed in a subsequent step by applying a vacuum.

For producing the glass laminate, the preform passes through a hot zone so as to form a drawing onion and is redrawn in its viscous state.

The preform comprises at least a first and a second glass with different coefficients of thermal expansion, the second glass having a higher coefficient of thermal expansion than the first glass.

The first glass is provided in the form of a glass tube of a length L having two sides, or faces, that extend over a width B.

The glass tube may have an ovaloid shape, the term ovaloid or ovaloid tube being not limited to oval tubes, although including them. An ovaloid tube is defined as a tube having a non-circular cross section, that means a tube having a longer extension in a first direction perpendicular to the longitudinal extension of the longitudinal axis of the tube than in a second direction perpendicular to the longitudinal extension of the tube.

An ovaloid tube may, for example, be obtained by hot-shaping a tube by means of two rollers, whereby the cross section of this tube is reduced in one direction perpendicular to the longitudinal axis of the tube.

Preferably, however, the first glass is provided in the form of a glass tube of a length L with two plane-parallel sides, or faces, extending over a width B, which are spaced apart from each other by a distance D_{V}. The following holds for quantities B and D_{V}: L>B>D_{V}. A rectangular cross-sectional shape is preferred. In this case, the preform is configured so that the second glass is located inside the glass tube. The second glass will also be referred to as the inner glass below, and the first glass as the outer glass. The inner and outer glasses are not connected in a force-fitted manner to each other in the preform, that means the preform is not a composite material, in contrast to the laminate of the invention. More particularly, the preform is not provided by bonding two glasses.

As mentioned in the introductory part, US 2011/200804 A1 describes a method for producing a glass laminate of increased strength by redrawing glasses having different thermal expansion coefficients, in which a preform consisting of three different sheet glasses is used. However, since sheet glasses usually may exhibit both thickness variations and deviations in their composition, such methods will commonly involve the risk of introducing warp, hence the risk of introducing distortions caused by asymmetrical stresses, which is generally undesirable. Both thickness variations and deviations in the composition of the glasses may cause locally deviating forces during redrawing and during cooling and may cause the distortions mentioned above. By contrast, an advantage of the present method is the use of a glass tube instead of the outer sheet glasses. In this way, the edges of the inner glass are enveloped, and a force compensation may be accomplished beyond the edges of the inner glass through the glass of the tube, at least during viscous phases of the glass(es), which will regularly lead to lower warp and therefore to better and dimensionally more stable shaping results.

The two small sides or edges of the glass tube may have any selectable contour. Conceivable are straight line, triangular, semi-elliptical, semi-circular contours, free-form surfaces, etc. A taper at the small sides of the glass tube prevents or at least minimizes a formation of bulging edges.

The tube of the first glass preferably has a rectangular or at least approximately rectangular cross-sectional shape, that means straight small sides, and is fused at the lower end of the tube, that is to say the outer glass tube is sealed at one end thereof. The second glass is inserted into the first glass tube fused at the lower end.

The second glass is a solid material. In a preferred embodiment, the second glass is a sheet glass. According to this embodiment, the preform comprises an outer glass tube made of a first glass and a sheet glass core made of a second glass.

Preferably, the preform has a flat shape. A flat preform refers to a preform which has a width B that is greater than a thickness D_{V} thereof.

According to one embodiment of the invention, the outer glass tube of the preform is produced by a fusing process from sheet glass panes. The outer rectangular glass tube may as well be obtained by reshaping a conventional glass tube of circular cross section. An appropriate method is described in patent document DE 10 2006 015 223 B3, for example.

Another embodiment contemplates that the outer rectangular glass tube is produced from a sheet glass by a laser-based reshaping process. For this purpose, the relevant sheet glass is hot-formed at least four times using a laser, wherein an angle of 90° or at least approximately 90° is formed in each of the reshaping processes. The two open edges are then fused together, so that a glass tube with a rectangular or approximately rectangular cross section is produced. Preferably, but not necessarily, the open edges are fused together at the small side of the rectangular tube.

The reshaping by means of laser radiation is particularly advantageous since the glass is heated and reshaped only in a locally limited area. Therefore, the properties of the surface of the starting glass will be retained. A further advantage of the laser-based reshaping is that a sheet glass is used as the starting glass. Thus, a quick and flexible change between different types of glass or between glasses of different thicknesses is possible during manufacturing, so that outer glass tubes can be made from different glasses and/or with different wall thicknesses without major process engineering effort.

A further preferred embodiment moreover comprises a method for producing a glass article that has a compressive stress zone close to the surface by redrawing, comprising at least the steps of: providing a preform, the preform comprising at least a first and a second glass, wherein the second glass has a higher thermal expansion coefficient than the first glass, wherein the first glass has a length L with two sides extending over a width B, and wherein the second glass is located between the two sides of the first glass extending over a length L; wherein the first glass has lateral portions extending beyond the second glass at lateral sides thereof; redrawing the preform, wherein the preform passes through a hot zone to form a drawing onion and is subsequently reshaped by application of mechanical force; wherein during the redrawing the lateral portions of the first glass extending beyond the second glass at lateral sides thereof form a laterally sealed body, in particular in the form of a glass tube of non-round cross section, which encloses the second glass.

According to a preferred embodiment of the invention, a vacuum is applied to the provided preform. In this manner, the air located between the individual glasses of the preform is removed. This process step is performed in the cold zone, i.e. at temperatures far below the transformation temperature of the glass, for example at room temperature. In this manner, air pockets are prevented from remaining in the glass in the subsequent process step. Moreover, the air can be removed much more easily in this process step than in the hot zone. For this purpose, a vacuum can be applied to the outer glass tube, for example, so that the outer glass tube is pressed against the second glass inside the outer glass tube by virtue of the atmospheric pressure. This prevents the formation of air pockets at the interface. For this purpose, the upper end of the outer glass tube can be connected to a vacuum generating device, for example a vacuum pump. This device may simultaneously be used as a holding device for the redrawing process.

The provided preform passes through a hot zone, whereby the preform is heated in a small region thereof known as deformation zone, so that a drawing onion is formed in the viscous state of the glasses. With the arrangement of the individual glasses in the preform it is possible to achieve that a common drawing onion is being formed from the two glasses. In this manner it can be ensured that the outer and inner glasses of the preform are jointly redrawn during the subsequent application of mechanical force since they are firmly attached to each other. The so obtained glass article is therefore provided in the form of a composite material comprising an outer and an inner glass, the outer glass being defined by the first glass and the inner glass by the second glass, and the inner glass being completely enclosed by the outer glass. The outer and inner glasses are connected to each other over their entire surface areas and in non-positive manner, in particular by being fused together.

In the hot zone, the preform is heated to a temperature at which the glasses have a sufficiently low viscosity to provide for a formation of a drawing onion and thus to allow redrawing and optionally reshaping. With the formation of a drawing onion, the air contained in the preform can easily escape upward. In this case, the total thickness of the redrawn glass may be significantly smaller than the total thickness of the preform. The total thickness of the redrawn glass can be adjusted through the redrawing process parameters, for example the drawing rate or viscosity of the glass in the deformation zone. Therefore, glass laminates of different thicknesses can be obtained from a preform. The thickness ratio of inner to outer glass, however, remains unchanged. Therefore, the thickness ratio of the inner to the outer glass is determined by the ratio of the wall thickness of the glass tube used in the preform and the thickness of the second glass. The manufacturing method according to the invention furthermore permits to produce glass thicknesses and glass thickness ratios with high precision, i.e. with tight tolerances, and therefore permits to adjust the resulting mechanical stresses in the glass.

Since the inner glass has a greater coefficient of thermal expansion than the outer glass, the inner glass will contract more strongly than the outer glass after having been heated and during subsequent cooling, so that a compressive stress zone is created in the laminate in the region of the outer glass and tensile stress is created in the region defined by the inner glass. Thus, the method of the invention permits to obtain a prestress without subjecting the glass to a tempering process (i.e. thermal or chemical tempering) as it is commonly understood. Rather, with the aforementioned method a compressive stress zone is produced and the glass article is toughened during the redrawing, so that process steps can be dispensed with. In addition, a compressive stress zone produced by the method of the invention is superior to a compressive stress zone produced by thermal or chemical tempering in that the prestress produced according to the invention will be reversibly reestablished even in case of reheating, after cooling, and therefore will overall be preserved. Thus, the compressive stress zone is thermally stable. Therefore, the redrawing step may be followed by process steps during which the glass is reheated.

In this case, the glass located further inwards might be smaller or become smaller in its transverse extension, i.e. in a direction perpendicular to its thickness than the transverse extension of a respective glass located further outwards, when being redrawn.

According to a further embodiment of the invention, the redrawing process is followed by reshaping of the glass laminate.

A further advantage of the method according to the invention is that, unlike in an overflow fusion process, for example, the two glasses need not be provided as a melt. This is particularly advantageous in the case of glasses which exhibit a strong crystallization tendency. Thus, an advantage of the method according to the invention compared to an overflow fusion process is that even glasses can be used which exhibit a crystal growth rate of greater than 0.5 μm/min in the viscosity range from 10⁴ to 10⁵ dPa·s. For example, one embodiment uses glasses as the first and/or second glass, which have a crystallization rate of >0.5 μm/min, in particular >1 μm/min, or even >5 μm/min, in the viscosity range from 10⁴ to 10⁵ dPa·s.

Moreover, the employed glasses are easily exchangeable in the method according to the invention.

Furthermore, as mentioned above, even prefabricated glass tubes and/or sheet glasses may be used for producing the preform. Relevant glass tubes and/or glasses are available at low costs and with narrow tolerances, so that a variety of selectively prestressed glass articles with different compressive stresses and/or compositions can be obtained with the method according to the invention.

According to a first embodiment of the invention, the first glass has a thermal expansion coefficient in a range from 0.1*10⁻⁶/K to 8*10⁻⁶/K, preferably in a range from 0.1*10⁻⁶/K to 6*10⁻⁶/K, and more preferably in a range from 0.1*10⁻⁶/K to 3.5*10⁻⁶/K, and/or the second glass has a thermal expansion coefficient in a range from 6*10⁻⁶/K to 20*10⁻⁶/K, preferably in a range from 8.7*10⁻⁶/K to 20*10⁻⁶/K, and more preferably in a range from 10*10⁻⁶/K to 20*10⁻⁶/K. Throughout the present description, thermal expansion coefficient refers to the coefficient of linear thermal expansion, preferably in a temperature range from 20 to 300° C.

According to yet another embodiment, the first glass has a thermal expansion coefficient in a range from −0.1*10⁻⁶/K to 12*10⁻⁶/K, preferably from 2.5*10⁻⁶/K to 10.5*10⁻⁶/K, and more preferably from 2.5*10⁻⁶/K to 9.1*10⁻⁶/K, and/or the second glass (3) has a thermal expansion coefficient in a range from 0*10⁻⁶/K to 12.1*10⁻⁶/K, preferably in a range from 2.6*10⁻⁶/K to 10.6*10⁻⁶/K, and more preferably in a range from 2.6*10⁻⁶/K to 9.2*10⁻⁶/K.

The ratio r_{α} of the thermal expansion coefficients of the second glass (3) to the first glass

r_{α}=α_{glass2}/α_{glass1}.

is >1.03, preferably >2, and more preferably >2.5, and most preferably >5, and this ratio preferably has an absolute value of less than 125.

Furthermore, the difference Δ_{α} of the thermal expansion coefficients between the second glass (3) and the first glass Δ_{α}=α_{glass2}−α_{glass1} is from 0.1 to 12*10⁻⁶/K, preferably from 0.1 to 5*10⁻⁶/K, more preferably from 0.1 to 2.5*10⁻⁶/K, and most preferably from 0.1 to 0.8*10⁻⁶/K.

The first glass can for example be a borosilicate glass, a glass ceramic, a green glass that can be converted into a glass ceramic by ceramization, or an alkali silicate glass, and/or the second glass can be a soda-lime glass, a waterglass, a lithium aluminosilicate glass, an alkali metal aluminosilicate glass, an aluminosilicate glass, or an alkali silicate glass. By selectively choosing the glasses with their thermal expansion coefficients it is possible to adjust the amount of compressive stress as well as other properties of the prestressed glass, such as for example chemical resistance or the refractive index.

The compressive stresses and profiles of compressive stresses or stress profiles in the glass produced according to the invention can be adjusted not only through the thermal expansion coefficients of the employed glasses, but also by the wall thicknesses of the glass tubes or sheet glasses used for producing the preform and by the ratio of wall thicknesses of the inner glass to the outer glass of the preform. In this manner, glasses with tailored properties can be obtained. For example, the stress profile of the glass can be adjusted so that an appropriately large-sized prestressed glass can easily be cut to size despite of its high strength.

According to a modification of the invention it is contemplated that a preform is provided which in addition to a first glass and a second glass comprises a third glass. In this case, the third glass is provided in the form of a glass tube and is arranged in the preform between the first glass and the second glass. The third glass is a glass tube with a rectangular or at least substantially rectangular cross-sectional shape and is located inside the outer glass tube made of the first glass. Inside the glass tube made of the third glass, the second glass is disposed, preferably in the form of a sheet glass. In other words, the third glass is disposed between the first glass and the second glass in the preform.

In a further embodiment, the third glass may as well consist of two sheet glasses which are disposed to the right and left of the second glass.

Such an embodiment is advantageous, for example, if a glass laminate with very high prestresses is desired. Big differences between the expansion coefficients of the first and second glasses are necessary in this case. A glass with a thermal expansion coefficient between the expansion coefficients of the first and second glasses can then be selected as a third glass, for example. In such an embodiment, the third glass is a transition glass for adapting the thermal expansion coefficients of the first and second glasses. The third glass advantageously has a third coefficient of thermal expansion which is smaller than the second coefficient of thermal expansion and greater than the first coefficient of thermal expansion.

In a further embodiment of the modification described above, a colored third glass is used. This permits to influence the color appearance of the glass laminate without having to add additional coloring components to the first or second glasses.

In addition to the high flexibility of the manufacturing method according to the invention, another advantage is that further process steps can follow, because of the temperature stability of the compressive stress zone described above.

According to a further embodiment of the invention it is contemplated that the step of redrawing is followed by further process steps such as for example coating processes. For example, the glass article may be coated on one or both faces thereof. The coatings may for example include coatings for increasing scratch resistance, in particular a sapphire glass coating, or oleophobic coatings, for example easy-to-clean and anti-fingerprint coatings. The coating may as well be an anti-glare coating, an anti-reflective coating, and/or an anti-bacterial coating. Multi-layered coatings are also possible.

Such coatings are partly applied at temperatures of up to 500° C., so that the compressive stress of thermally or chemically tempered glasses would be at least partially offset, in contrast to the glasses produced according to the invention.

According to another embodiment of the invention it is contemplated that the glass produced by the method according to the invention is additionally thermally or chemically tempered in a subsequent step. In this manner, the compressive stress can be further increased. Thermal or chemical tempering is preferably effected in the region of the glass which is defined by the first, outer glass in this case. As a result, an additional compressive stress is created at the surface of the outer glass, while a tensile stress is created in the lower regions of the outer glass. This changes the stress profile of the glass. Thus, additional thermal or chemical tempering provides a further option to adjust the compressive stress and the stress profile of the glass. However, the additional compressive stress generated by the thermal or chemical tempering might be offset by high temperatures.

The method of the invention is particularly suitable for producing thin sheet glasses, in particular for producing glasses having a thickness of <3 mm. It is even possible to produce prestressed sheet glasses having a thickness of <0.5 mm, <0.2 mm, <0.1 mm, or even <0.05 mm, or even 0.025 mm.

The glass article produced by the present method in particular also comprises a thin glass ribbon or a glass film having a thickness of less than 350 μm, preferably less than 250 μm, more preferably less than 100 μm, even more preferably less than 50 μm, most preferably less than 25 μm, and with a lower limit of 5 μm, preferably of 3 μm. Preferred glass film thicknesses include 5 μm, 10 μm, 15 μm, 25 μm, 30 μm, 35 μm, 50 μm, 55 μm, 70 μm, 80 μm, 100 μm, 130 μm, 145 μm, 160 μm, 190 μm, 210 μm, and 280 μm.

A glass of increased strength according to the invention is provided in the form of a glass laminate. The glass laminate comprises a layer composite with at least three layers comprising two different glasses. The individual layers of the layer composite are connected to each other over their entire surface areas and in a non-positive manner, in particular by being fused together. The two outer layers of the layer composite are formed by a first glass. The first glass is also referred to as the outer glass below. The innermost layer of the layer composite is formed by a second, inner glass. The layer composite is configured so that the layer made of the second glass is disposed between the two layers made of the first glass. The individual layers of the layer composite are joined to each other through common interfaces. In particular, the individual layers are attached to each other without adhesion promoter.

The first glass has a first thermal expansion coefficient and the second glass has a second thermal expansion coefficient. The expansion coefficient of the first glass is smaller than the expansion coefficient of the second glass. As a result thereof, the glass or glass laminate according to the invention has a compressive stress zone in the regions close to the surface and a tensile stress zone in the inner region thereof. The compressive stress zone of the glass according to the invention is thermally stable.

In a modification of the invention, the glass laminate comprises at least two layers made of a third glass in addition to the layers made of the first and second glasses. The layers made of the third glass are arranged between the layers made of the first and second glasses. In this case, too, all individual layers of the layer composite are connected to the adjacent layers over their entire surface areas through respective common interfaces, in particular by being fused together.

In this case, the additional layer is introduced during the manufacturing process using a second glass tube or two sheet glasses, as described above.

In the context of the present invention, thermally stable compressive stress zone refers to a compressive stress zone exhibiting compressive stress that is not irreversibly relieved or reduced when the glass is heated, in particular when the glass is heated to a temperature close to the softening temperature T_{g} or above, but rather will be reestablished after cooling. Therefore, a glass according to the invention will exhibit constant or at least substantially constant compressive stress even after several heating and cooling cycles.

According to one embodiment of the invention, the compressive stress is at most 800 MPa, preferably at most 600 MPa, and more preferably at most 400 MPa, and preferably at least 20 MPa.

According to a first embodiment of the invention, the first glass has a thermal expansion coefficient in a range from 0.1*10⁻⁶/K to 8*10⁻⁶/K, preferably in a range from 0.1*10⁻⁶/K to 6*10⁻⁶/K, and more preferably in a range from 0.1*10⁻⁶/K to 3.5*10⁻⁶/K, and/or the second glass has a thermal expansion coefficient in a range from 6*10⁻⁶/K to 20*10⁻⁶/K, preferably in a range from 8.7*10⁻⁶/K to 20*10⁻⁶/K, and more preferably in a range from 10*10⁻⁶/K to 20*10⁻⁶/K.

In yet another embodiment, the first glass has a thermal expansion coefficient in a range from −0.1*10⁻⁶/K to 12*10⁻⁶/K, preferably from 2.5*10⁻⁶/K to 10.5*10⁻⁶/K, and more preferably from 2.5*10⁻⁶/K to 9.1*10⁻⁶/K, and/or the second glass (3) has a thermal expansion coefficient in a range from 0*10⁻⁶/K to 12.1*10⁻⁶/K, preferably in a range from 2.6*10⁻⁶/K to 10.6*10⁻⁶/K, and more preferably in a range from 2.6*10⁻⁶/K to 9.2*10⁻⁶/K.

The ratio r_{α} of the thermal expansion coefficients of the second glass (3) to the first glass

r_{α}=α_{glass2}/α_{glass1}.

is >1.03, preferably >2, and more preferably >2.5, and most preferably >5, and this ratio preferably has an absolute value of less than 125.

Furthermore, the difference Δ_{α} between the thermal expansion coefficients of the second glass (3) and the first glass

Δ_{α}=α_{glass2}−α_{glass1}

is from 0.1 to 12*10⁻⁶/K, preferably from 0.1 to 5*10⁻⁶/K, more preferably from 0.1 to 2.5*10⁻⁶/K, and most preferably from 0.1 to 0.8*10⁻⁶/K.

Glass laminates of the first embodiment with a first thermal expansion coefficient in a range from 0.1*10⁻⁶/K to 8*10⁻⁶/K, preferably in a range from 0.1*10⁻⁶/K to 6*10⁻⁶/K, and more preferably in a range from 0.1*10⁻⁶/K to 3.5*10⁻⁶/K, and/or with a second thermal expansion coefficient in a range from 6*10⁻⁶/K to 20*10⁻⁶/K, preferably in a range from 8.7*10⁻⁶/K to 20*10⁻⁶/K, and more preferably in a range from 10*10⁻⁶/K to 20*10⁻⁶/K and glass laminates of the further modification mentioned above exhibit particularly high compressive stresses.

The amount of compressive stress and the compressive stress profile are dependent on the difference between the two coefficients of thermal expansion and on the thicknesses of the individual glass layers. Particularly high compressive stresses can in particular be achieved if the ratio r_{α}

r_{α}=α_{glass2}/α_{glass1}

of the second thermal expansion coefficient to the first thermal expansion coefficient is greater than 1.5, preferably greater than 2, and more preferably greater than 2.5. This also applies to the glasses of the further modification, in particular if for these glasses the ratio r_{α} of the second thermal expansion coefficient to the first thermal expansion coefficient is >1.03, preferably >2, and more preferably >2.5, and most preferably >5 and if this ratio preferably has an absolute value of less than 125.

The glass laminate may comprise layers made of different glasses and types of glass. According to one embodiment it is contemplated that the first glass is a borosilicate glass, a glass ceramic, a green glass that can be converted into a glass ceramic by ceramization, or an alkali silicate glass, and/or that the second glass is a soda-lime glass, a waterglass, a lithium aluminosilicate glass, an alkali metal aluminosilicate glass, an aluminosilicate glass, or an alkali silicate glass.

According to one embodiment, the glass laminate has a thickness of at most 3 mm, preferably at most 0.7 mm, and more preferably at most 0.1 mm. Thus, the glass laminate according to the invention may be a thin glass. Due to the increased strength, such thin glasses can be employed as display covers, for example.

The glass article produced by the present method in particular also comprises a thin glass ribbon or a glass film having a thickness of less than 350 μm, preferably less than 250 μm, more preferably less than 100 μm, most preferably less than 50 μm, and preferably of at least 3 μm, more preferably of at least 10 μm, most preferably of at least 15 μm. Preferred glass film thicknesses are 5 μm, 10 μm, 15 μm, 25 μm, 30 μm, 35 μm, 50 μm, 55 μm, 70 μm, 80 μm, 100 μm, 130 μm, 145 μm, 160 μm, 190 μm, 210 μm, and 280 μm.

According to a refinement of the invention, the glass laminate is additionally thermally or chemically tempered. So, in addition to the prestress according to the present invention, the glass laminate has a prestress achieved by thermal or chemical tempering.

Alternatively or additionally, the glass laminate may have a coating applied to one or both faces thereof. The coating may be provided as a single-layer coating or may include a plurality of layers. The coating may for example be a coating for increasing scratch resistance, in particular a sapphire glass coating, an easy-to-clean coating, an anti-fingerprint coating, an anti-glare coating, an anti-reflective coating, and/or an anti-bacterial coating. In another embodiment, the glass laminate is coated with an interference optical coating.

The glass laminate according to the invention can be produced by a redrawing process. The glass laminate is preferably produced by the method according to the invention.

### DESCRIPTION OF THE FIGURES

The invention will now be described in more detail by way of exemplary embodiments and with reference to FIGS. 1 to 9, wherein:

FIG. 1 schematically illustrates a first embodiment of the method according to the invention;

FIG. 2 schematically illustrates a further embodiment of the method according to the invention;

FIG. 3 is a schematic view of one embodiment of the laminate according to the invention;

FIG. 4 is a schematic view of a further embodiment of the glass laminate, in which the glass laminate is coated on one face thereof;

FIG. 5 is a schematic view of a further embodiment of the glass laminate, in which the glass laminate comprises a third glass;

FIG. 6a is a view of the lower end of the glass tube having a rectangular cross section;

FIG. 6b is a view of the lower end of the glass tube having a hexagonal cross section; and

FIG. 6c is a view of the lower end of the glass tube having rounded edges;

FIG. 7 is a schematic cross-sectional view of a preferred embodiment of a preform according to the invention prior to redrawing;

FIG. 8 is a schematic cross-sectional view of the preferred embodiment of a preform according to the invention shown in FIG. 7 during hot reshaping thereof, in particular during redrawing;

FIG. 9 is a schematic cross-sectional view of the preferred embodiment of a preform according to the invention shown in FIGS. 7 and 8 during hot reshaping thereof, in particular after application of a vacuum.

### DETAILED DESCRIPTION

In the following detailed description of preferred embodiments, the same reference numerals designate substantially similar or identical components or features.

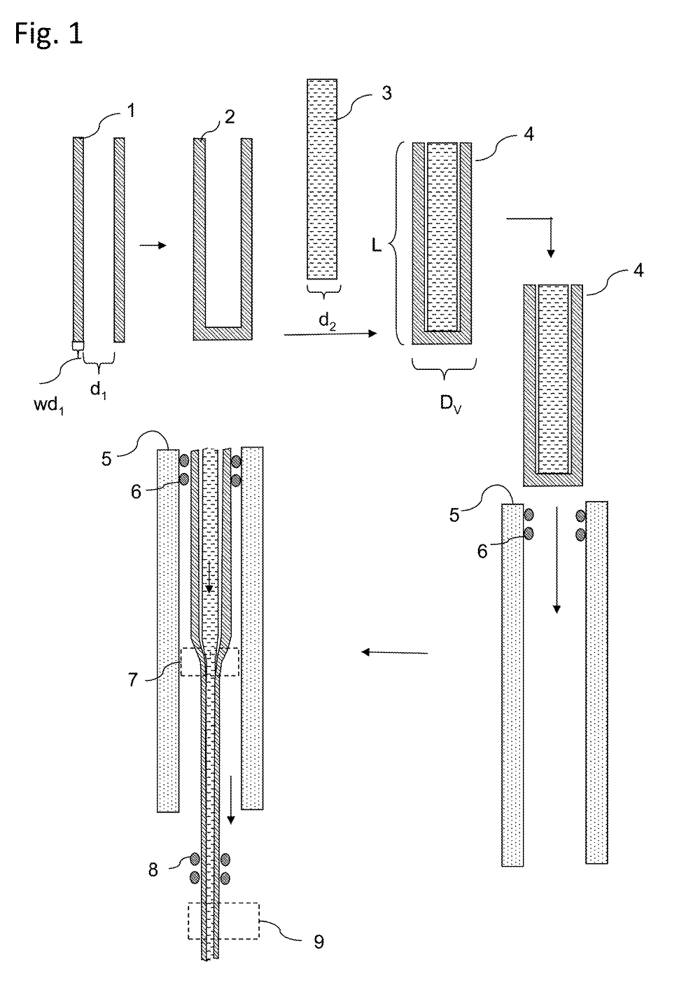

FIG. 1 schematically illustrates a sequence of method steps according to a first embodiment of the inventive method, the items employed in the method steps being shown in a longitudinal cross-sectional view.

First, a glass tube 1 of length L is provided, which has a preferably rectangular or oval cross-sectional shape. Glass tube 1 is made of a first glass and has an inner spacing, also referred to as inner diameter d₁, and a wall thickness wd₁.

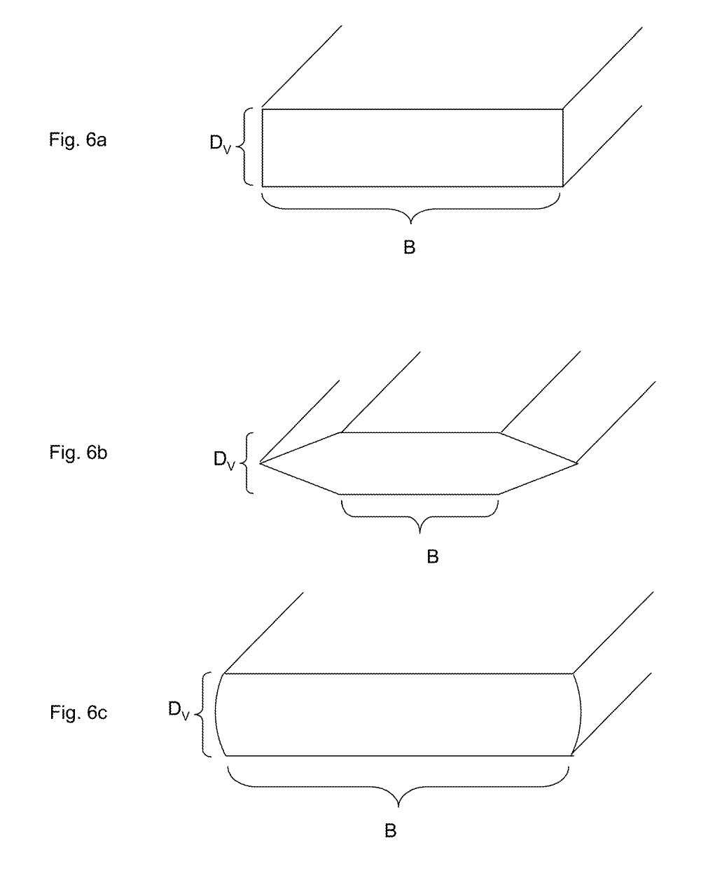

The long plane-parallel sides of the glass tube extend over a width B (see FIGS. 6a to 6c) and are spaced from each other by an inner spacing d1. For these parameters, the relationship L>B>d1 applies.

In step a), the glass tube 1 is preferably sealed at one end thereof, by fusing.

In step b), a sheet glass of a thickness d₂ and made of a second glass 3 is introduced into the glass tube 2 sealed at one end.

Sheet glass 3 has a thickness d₂ which is smaller than the inner spacing d₁ of the first tube 1, so that the sheet glass 3 can be inserted into the glass tube 2.

The glasses of first glass tube 1 and of sheet glass 3 differ in their coefficients of thermal expansion, the thermal expansion coefficient of the first glass being smaller than the thermal expansion coefficient of the second glass.

The two interposed glasses, i.e. glass tube 2 and sheet glass 3, define the preform 4.

The outer dimension, also referred to as the outer diameter D_{V} of preform 4 corresponds to the outer dimension of the first glass tube 1.

Preform 4 is introduced into a redrawing apparatus 10 by means of rollers 6.

The apparatus 10 shown in FIG. 1 is illustrated in simplified form and merely represents one example of a possible redrawing apparatus. The walls 5 of apparatus 10 include heaters (not shown), by means of which the preform 4 is heated.

Preform 4 is passed through apparatus 10 by rollers 6 and 8, the arrows symbolizing the advancement direction of the preform.

During redrawing, a common drawing onion of the two glasses 1 and 3 in their viscous state is being formed within hot zone 7. As a result of the redrawing, a full-surface and non-positive connection is created between the first and second glasses 1, 3, in particular by fusion along the surfaces thereof.

Thus, a three-layered glass laminate 9 is provided as the result of redrawing. Contact is established between the walls of the first tube 1 and the surfaces of sheet glass 3. Sheet glass 3 thus forms the inner layer of the laminate, while the two outer layers of the laminate are defined by the glass of first glass tube 1.

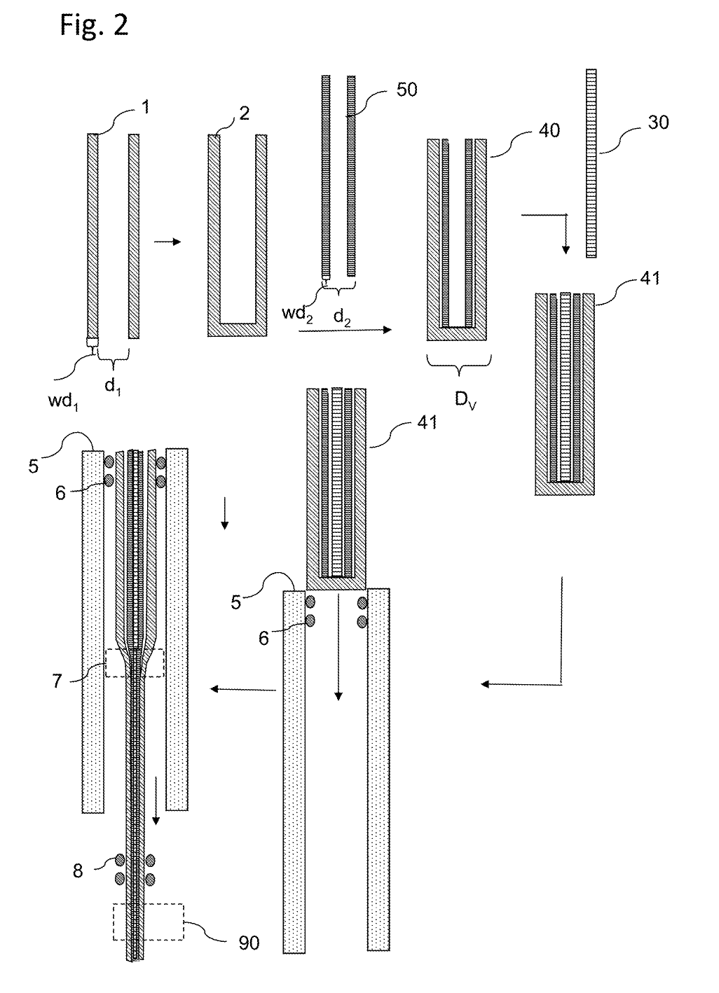

FIG. 2 schematically shows the process sequence of a further embodiment of the method, the method steps being illustrated in a longitudinal cross-sectional view.

The further embodiment shown in FIG. 2 differs from the exemplary embodiment of FIG. 1 in that a glass tube 50 made of a third glass is additionally used.

Glass tube 1 is made of a first glass and has an inner spacing d₁ and a wall thickness wd₁. In step a), the glass tube 1 is sealed at one end thereof by fusing.

A further glass tube 50 having a wall thickness wd₂ is introduced into the so obtained glass tube 2 sealed at one end, in step b). Glass tube 50 has a rectangular or ovaloid cross section and an outer dimension d₂ which is smaller than the inner spacing d₁ of the first tube 1, so that the glass tube 50 can be inserted into the glass tube 2.

Glass tube 50 is made of a third glass. Subsequently, a glass 30 in the form of a sheet glass is inserted into glass tube 50.

The first and second glasses differ in their thermal expansion coefficients, the thermal expansion coefficient of the first glass being smaller than the thermal expansion coefficient of the second glass.

Depending on the embodiment, the third glass, i.e. the glass of glass tube 50, may have a thermal expansion coefficient between the expansion coefficients of the first and second glasses. Alternatively or additionally, the third glass may contain coloring components.

The interleaved glass tubes 2 and 50 together with sheet glass 30 define the preform 41. The outer dimension D_{V} of preform 41 corresponds to the outer dimension of the first glass tube 1.

Preform 41 is introduced into a redrawing apparatus 10 by means of rollers 6. As a result of the redrawing, a full-surface and non-positive connection is created between the three components 2, 50, and 30 of the preform 41, in particular by fusion. Thus, a five-layered glass laminate 90 is provided as the result of redrawing.

Surface contact is established between the walls of the first tube 1 and the walls of tube 50 and also between the two walls of tube 50 and the two faces of sheet glass 30. Sheet glass 30 defines the inner layer of the laminate, while the walls of glass tube 50 each define an intermediate layer and the walls of the first glass tube 1 define the two outer layers of the laminate 90.

Preferably, in this case, the respective glasses are selected so that the glasses disposed further inwards have a higher coefficient of thermal expansion than the glasses disposed further outwards or at least than the outermost first glass of glass tube 1. In this way, a gradient-like increase of compressive stress from the interior towards the exterior of laminate 90 can be achieved, which may even be stronger than in the case of glass laminates comprising a smaller number of glasses, and nevertheless the warp arising during shaping, in particular during redrawing, will usually be less pronounced.

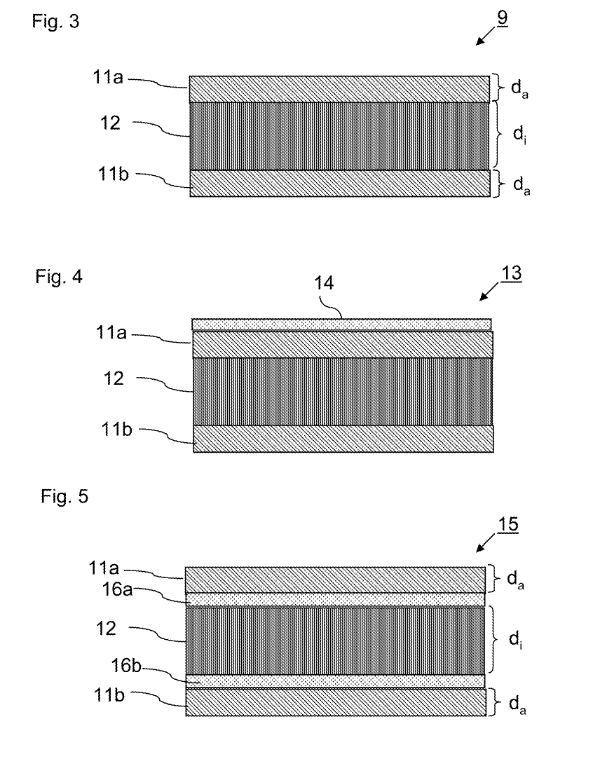

FIG. 3 schematically illustrates a cross-sectional view through glass laminate 9. In this embodiment, the glass laminate comprises three glass layers 11a, 12, and 11b in the form of a layer composite. The outer layers 11a and 11b are made of the first glass. The inner glass layer 12 is disposed between outer layers 11a and 11b, the individual glass layers sharing common interfaces. Inner glass layer 12 is made of the second glass.

Layers 11a and 11b each have a layer thickness dₐ, the layer thickness of the inner layer 12 is denoted by dᵢ. The glass laminate 9 has a total thickness D_{L}. Depending on the selected process parameters during the redrawing process, the total thickness D_{L} of the glass laminate is smaller than the total thickness D_{V} of the preform, which corresponds to the outer dimension of glass tube 2.

FIG. 4 schematically illustrates a further embodiment of the glass laminate according to the invention. In this embodiment, the glass laminate 13 is coated on one face thereof. The coating 14 may, for example, be a coating 14 for increasing scratch resistance, a sapphire glass coating, an easy-to-clean coating, an anti-fingerprint coating, an anti-glare coating, an anti-reflective coating, and/or an anti-bacterial coating.

FIG. 5 illustrates a further embodiment of the invention in which the glass laminate 15 comprises layers made of a third glass, 16a and 16b.

Layers 16a and 16b are disposed between layers 11a and 11b, respectively, and the inner layer 12. In this case, the ratio of the thickness dₐ of the two outer layers 11a and 11b to the thickness dₘ of layers 16a and 16b corresponds to the ratio of wall thicknesses wd₁ and wd₂ of the two glass tubes 1 and 50 in the preform 41 (see FIG. 2). Thus, the following applies:

2dₐ/dₘ=wd₁/wd₂

FIGS. 6a, 6b, 6c show views of the lower end of the glass tube 1, corresponding to the respective cross section thereof, with different configurations of the small sides, or edges.

In FIG. 6a the lower end of glass tube 1 has the shape of a rectangle and in FIG. 6b the shape of a hexagon. In FIG. 6c, the lower end has rounded lateral sides, or edges.

In all three FIGS. 6a, 6b, and 6c, the thickness D_{V} and the width B or extension of the plane-parallel sides or faces are indicated.

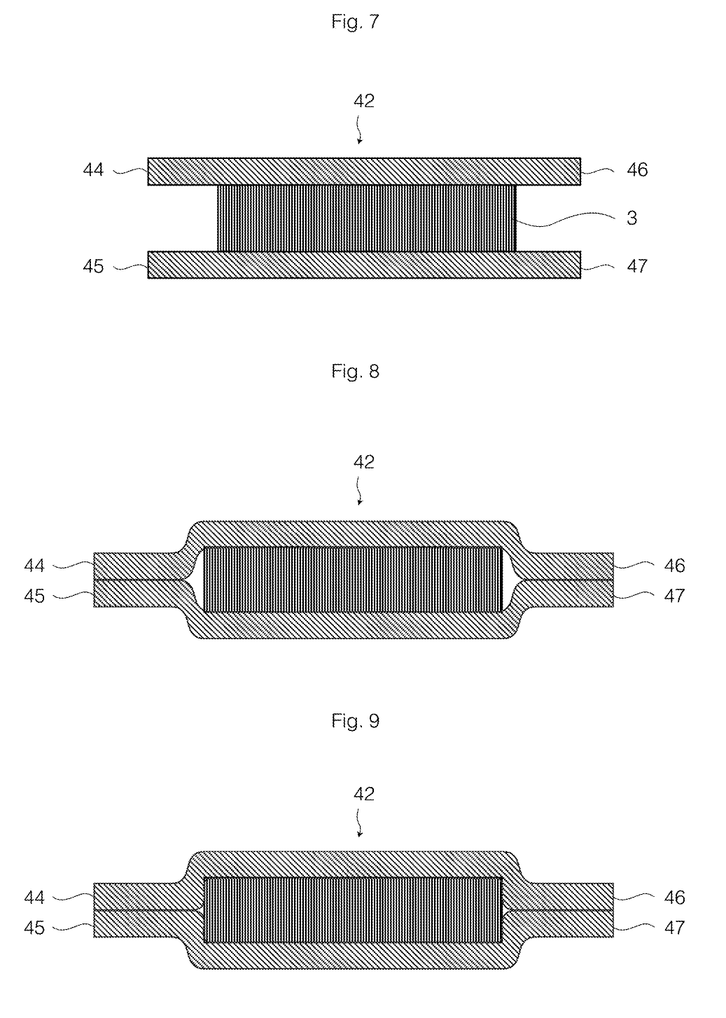

Reference is now made to FIG. 7 which shows a schematic cross-sectional view of a further preform 42 prior to being redrawn, which is in particular employed for a further embodiment of the inventive method for producing a glass article.

In this embodiment, again, reference numerals already mentioned above designate the same or equivalent components.

In this further embodiment, the method for producing a glass article with a compressive stress zone close to the surface by redrawing comprises at least the steps of: a) providing a preform 42, the preform 42 comprising at least a first and a second glass 3, wherein the second glass 3 has a higher thermal expansion coefficient than the first glass, wherein the first glass has a length L with two sides extending over a width B, and wherein the second glass 3 is arranged between the two sides of the first glass 1 extending over a length L.

As an alternative to the first embodiment according to the invention, the first glass has lateral portions 44, 45, 46, 47 extending beyond the second glass at lateral sides thereof and is provided in the form of a respective sheet glass in step b).

FIG. 8 is a schematic cross-sectional view of the preferred embodiment of a preform 42 according to the invention shown in FIG. 7 during hot reshaping, in particular while being redrawn.

The lateral portions 44, 45, 46, 47 laterally extending beyond the second glass 3, are contacted to each other by appropriate means, such as for example by further, preferably heated rollers, not shown in the figures, during the viscous state of the first glass during hot-forming thereof in the hot zone, and in this embodiment, too, one end of the preform 42 may be sealed, for example also by hot-forming, in order to permit to subsequently apply a vacuum.

According to a preferred embodiment, in this embodiment too, the air located between the individual components of the preform 42 is removed in a subsequent step by applying a vacuum, which results in the deformation illustrated in FIG. 9.

Accordingly, FIG. 9 is a schematic cross-sectional view of the preform 42 shown in FIGS. 7 and 8 during hot-forming thereof, in particular during redrawing after a vacuum was applied.

Here, the portions 44, 45, 46, 47 of the first glass extending laterally beyond the second glass form a laterally sealed body during the redrawing, in particular in the form of an ovaloid glass tube of non-round cross section, which encloses the second glass 3.

Subsequently or essentially simultaneously, the redrawing of the preform 42 is effected by passing the preform 42 through the hot zone in order to form a drawing onion and then further shaping it by application of mechanical force.

Below, preferred glasses for carrying out the invention are given. Since the invention is not limited to a specific one of the glasses mentioned below, it is not a priori predefined whether the respective glass is an inner or outer glass, that is to say the first or second glass. For the purposes of the invention it suffice to take into account the values of the thermal expansion coefficients given in the independent claims by selecting the corresponding glasses. For this purpose, the thermal expansion coefficients, determined for a temperature range from 20° C. to 300° C. in each case, are also given below for each of the glasses. Wherever the thermal expansion coefficients are not specified as an exact value but as a range, the respective value of the thermal expansion coefficient for the respective exact composition employed need to be used, which may as well be determined, for example, by measurement on the respective employed glass.

According to one embodiment, at least one of the aforementioned glasses is a lithium aluminosilicate glass having a thermal expansion coefficient from 3.3 to 5.7*10⁻⁶/K and the following composition (in wt %):

TABLE 1

| Composition | (wt %) |
|---|---|
| SiO₂ | 55-69 |
| Al₂O₃ | 18-25 |
| Li₂O | 3-5 |
| Na₂O + K₂O | 0-30 |
| MgO + CaO + SrO + | 0-5 |
| BaO | |
| ZnO | 0-4 |
| TiO₂ | 0-5 |
| ZrO₂ | 0-5 |
| TiO₂ + ZrO₂ + SnO₂ | 2-6 |
| P₂O₅ | 0-8 |
| F | 0-1 |
| B₂O₃ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Preferably, the lithium aluminosilicate glass of one embodiment the invention has the following composition (in wt %), with a thermal expansion coefficient from 4.76 to 5.7*10⁻⁶/K:

TABLE 2

| Composition | (wt %) |
|---|---|
| SiO₂ | 57-66 |
| Al₂O₃ | 18-23 |
| Li₂O | 3-5 |
| Na₂O + K₂O | 3-25 |
| MgO + CaO + SrO + | 1-4 |
| BaO | |
| ZnO | 0-4 |
| TiO₂ | 0-4 |
| ZrO₂ | 0-5 |
| TiO₂ + ZrO₂ + SnO₂ | 2-6 |
| P₂O₅ | 0-7 |
| F | 0-1 |
| B₂O₃ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Most preferably, the lithium aluminosilicate glass of a preferred embodiment of the invention has the following composition (in wt %), with a thermal expansion coefficient from −0.068 to 1.16*10⁻⁶/K as a glass ceramic and with a thermal expansion coefficient from 5 to 7*10⁻⁶/K as a glass:

TABLE 3

| Composition | (wt %) |
|---|---|
| SiO₂ | 57-63 |
| Al₂O₃ | 18-22 |
| Li₂O | 3.5-5 |
| Na₂O + K₂O | 5-20 |
| MgO + CaO + SrO + | 0-5 |
| BaO | |
| ZnO | 0-3 |
| TiO₂ | 0-3 |
| ZrO₂ | 0-5 |
| TiO₂ + ZrO₂ + SnO₂ | 2-5 |
| P₂O₅ | 0-5 |
| F | 0-1 |
| B₂O₃ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

According to one embodiment, the glass is a soda-lime glass, comprising the following composition (in wt %), and with a thermal expansion coefficient from 5.33 to 9.77*10⁻⁶/K:

TABLE 4

| Composition | (wt %) |
|---|---|
| SiO₂ | 40-81 |
| Al₂O₃ | 0-6 |
| B₂O₃ | 0-5 |
| Li₂O + Na₂O + K₂O | 5-30 |
| MgO + CaO + SrO + BaO + | 5-30 |
| ZnO | |
| TiO₂ + ZrO₂ | 0-7 |
| P₂O₅ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Preferably, the soda-lime glass of one embodiment of the present invention has the following composition (in wt %), with a thermal expansion coefficient from 4.94 to 10.25*10⁻⁶/K:

TABLE 5

| Composition | (wt %) |
|---|---|
| SiO₂ | 50-81 |
| Al₂O₃ | 0-5 |
| B₂O₃ | 0-5 |
| Li₂O + Na₂O + K₂O | 5-28 |
| MgO + CaO + SrO + BaO + | 5-25 |
| ZnO | |
| TiO₂ + ZrO₂ | 0-6 |
| P₂O₅ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Most preferably, the soda-lime glass of the present invention has the following composition (in wt %), with a thermal expansion coefficient from 4.93 to 10.25*10⁻⁶/K:

TABLE 6

| Composition | (wt %) |
|---|---|
| SiO₂ | 55-76 |
| Al₂O₃ | 0-5 |
| B₂O₃ | 0-5 |
| Li₂O + Na₂O + K₂O | 5-25 |
| MgO + CaO + SrO + BaO + | 5-20 |
| ZnO | |
| TiO₂ + ZrO₂ | 0-5 |
| P₂O₅ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

According to one embodiment of the invention, the glass is a borosilicate glass of the following composition (in wt %), with a thermal expansion coefficient from 3.0 to 9.01*10⁻⁶/K:

TABLE 7

| Composition | (wt %) |
|---|---|
| SiO₂ | 60-85 |
| Al₂O₃ | 0-10 |
| B₂O₃ | 5-20 |
| Li₂O + Na₂O + K₂O | 2-16 |
| MgO + CaO + SrO + BaO + | 0-15 |
| ZnO | |
| TiO₂ + ZrO₂ | 0-5 |
| P₂O₅ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

More preferably, the borosilicate glass of one embodiment of the present invention has the following composition (in wt %), with a thermal expansion coefficient from 2.8 to 7.5*10⁻⁶/K:

TABLE 8

| Composition | (wt %) |
|---|---|
| SiO₂ | 63-84 |
| Al₂O₃ | 0-8 |
| B₂O₃ | 5-18 |
| Li₂O + Na₂O + K₂O | 3-14 |
| MgO + CaO + SrO + BaO + | 0-12 |
| ZnO | |
| TiO₂ + ZrO₂ | 0-4 |
| P₂O₅ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Most preferably, the borosilicate glass of one embodiment of the present invention has the following composition (in wt %) with a thermal expansion coefficient from 3.18 to 7.5*10⁻⁶/K:

TABLE 9

| Composition | (wt %) |
|---|---|
| SiO₂ | 63-83 |
| Al₂O₃ | 0-7 |
| B₂O₃ | 5-18 |
| Li₂O + Na₂O + K₂O | 4-14 |
| MgO + CaO + SrO + BaO + | 0-10 |
| ZnO | |
| TiO₂ + ZrO₂ | 0-3 |
| P₂O₅ | 0-2 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

According to one embodiment, the glass is an alkali metal aluminosilicate glass of the following composition (in wt %), with a thermal expansion coefficient from 3.3 to 10.0*10⁻⁶/K:

TABLE 10

| Composition | (wt %) |
|---|---|
| SiO₂ | 40-75 |
| Al₂O₃ | 10-30 |
| B₂O₃ | 0-20 |
| Li₂O + Na₂O + K₂O | 4-30 |
| MgO + CaO + SrO + BaO + | 0-15 |
| ZnO | |
| TiO₂ + ZrO₂ | 0-15 |
| P₂O₅ | 0-10 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

More preferably, the alkali metal aluminosilicate glass of one embodiment of the present invention has the following composition (in wt %), with a thermal expansion coefficient from 3.99 to 10.22*10⁻⁶/K:

TABLE 11

| Composition | (wt %) |
|---|---|
| SiO₂ | 50-70 |
| Al₂O₃ | 10-27 |
| B₂O₃ | 0-18 |
| Li₂O + Na₂O + K₂O | 5-28 |
| MgO + CaO + SrO + BaO + ZnO | 0-13 |
| TiO₂ + ZrO₂ | 0-13 |
| P₂O₅ | 0-9 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Most preferably, the alkali aluminosilicate glass of one embodiment of the present invention has the following composition (in wt %), with a thermal expansion coefficient from 4.4 to 9.08*10⁻⁶/K:

TABLE 12

| Composition | (wt %) |
|---|---|
| SiO₂ | 55-68 |
| Al₂O₃ | 10-27 |
| B₂O₃ | 0-15 |
| Li₂O + Na₂O + K₂O | 4-27 |
| MgO + CaO + SrO + BaO + | 0-12 |
| ZnO | |
| TiO₂ + ZrO₂ | 0-10 |
| P₂O₅ | 0-8 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

In one embodiment of the invention, the glass is an aluminosilicate glass having a low alkali content, with the following composition (in wt %) and with a thermal expansion coefficient from 2.8 to 6.5*10⁻⁶/K:

TABLE 13

| Composition | (wt %) |
|---|---|
| SiO₂ | 50-75 |
| Al₂O₃ | 7-25 |
| B₂O₃ | 0-20 |
| Li₂O + Na₂O + K₂O | 0-4 |
| MgO + CaO + SrO + BaO + | 5-25 |
| ZnO | |
| TiO₂ + ZrO₂ | 0-10 |
| P₂O₅ | 0-5 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

More preferably, the aluminosilicate glass of low alkali content according to one embodiment of the present invention has the following composition (in wt %), with a thermal expansion coefficient from 2.8 to 6.5*10⁻⁶/K:

TABLE 14

| Composition | (wt %) |
|---|---|
| SiO₂ | 52-73 |
| Al₂O₃ | 7-23 |
| B₂O₃ | 0-18 |
| Li₂O + Na₂O + K₂O | 0-4 |
| MgO + CaO + SrO + BaO + | 5-23 |
| ZnO | |
| TiO₂ + ZrO₂ | 0-10 |
| P₂O₅ | 0-5 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Most preferably, the aluminosilicate glass of low alkali content according to one embodiment of the present invention has the following composition (in wt %), with a thermal expansion coefficient from 2.8 to 6.5*10⁻⁶/K:

TABLE 15

| Composition | (wt %) |
|---|---|
| SiO₂ | 53-71 |
| Al₂O₃ | 7-22 |
| B₂O₃ | 0-18 |
| Li₂O + Na₂O + K₂O | 0-4 |
| MgO + CaO + SrO + BaO + | 5-22 |
| ZnO | |
| TiO₂ + ZrO₂ | 0-8 |
| P₂O₅ | 0-5 |

Optionally, coloring oxides may be added, such as Nd₂O₃, Fe₂O₃, CoO, NiO, V₂O₅, MnO₂, TiO₂, CuO, CeO₂, Cr₂O₃, from 0 to 2 wt % of As₂O₃, Sb₂O₃, SnO₂, SO₃, Cl, F, and/or CeO₂ may be added as a refining agent, and from 0 to 5 wt % of rare earth oxides may further be added to impart magnetic, photonic or optical functions to the glass layer or glass sheet, and the total amount of the total composition is 100 wt %.

Generally, the intermediate glass, i.e. the second glass or any of the glasses located inside the first glass may as well be introduced into the space between core glass and outer glass in the form of a powder or as a sheet, this means as sheet glass.

The inner and intermediate glasses may as well be introduced as a coated glass into the angular or ovaloid first (outer) glass.

In one embodiment, an amorphous mixture of silicon dioxide and aluminum oxide is used for this purpose, and through the mixing ratio thereof it is possible to adjust the amount of thermal expansion a and hence the prestress of the later redrawn glass laminate.

In case of a pure SiO₂ layer, the thermal expansion behavior is approximately that of quartz glass, and with an increasing proportion of Al₂O₃ (α=6.5 . . . 8.9*10⁻⁶/K) in the mixture, the α value and therefore the coefficient of thermal expansion will correspondingly change to larger values. This permits to achieve predefined values of compressive stress by adjusting the thermal expansion coefficient.

In a further embodiment, glasses of a specific predetermined composition are ground to powder and are applied to the second glass, i.e. the core glass, or to one of the inner glasses in a spraying or dipping process or in a screen printing process. In a dipping process, for example, coating thicknesses in a range from 10 nm to about 300 nm can be achieved (with a single application), greater layer thicknesses can be achieved by repeated application of the glass layer.

What is claimed is:

1. A method for producing a glass article that has a compressive stress zone close to the surface by redrawing, comprising at least the steps of:
providing a preform comprising at least a first glass and a second glass, the second glass having a higher thermal expansion coefficient than the first glass, the first glass being a glass tube of a length (L) with two sides extending over a width (B), and the second glass is located inside the glass tube; and
redrawing the preform so that the preform passes through a hot zone to form a drawing onion and is subsequently reshaped by application of mechanical force.

2. A method for producing a glass article that has a compressive stress zone close to the surface by redrawing, comprising at least the steps of:
providing a preform comprising at least a first glass and a second glass, the second glass has a higher thermal expansion coefficient than the first glass, the first glass has a length (L) with two sides extending over a width (B), and the second glass is located between the two sides of the first glass, the first glass has lateral portions extending beyond the second glass at lateral sides thereof;
redrawing the preform so that the preform passes through a hot zone to form a drawing onion and is subsequently reshaped by application of mechanical force, wherein during the redrawing the lateral portions of the first glass form a laterally sealed body that encloses the second glass.

3. The method as claimed in claim 1, wherein the glass tube has two plane-parallel sides extending over the width and arranged with a spacing (d₁) therebetween, wherein the length is larger than the width and the width is larger than the spacing.

4. The method as claimed in claim 1, wherein the preform has a rectangular or ovaloid cross-sectional shape.

5. The method as claimed in claim 1, wherein the second glass is a sheet glass.

6. The method as claimed in claim 1, wherein the first and second glasses are not connected in force-fitted manner to each other in the preform.

7. The method as claimed in claim 1, wherein the first glass is glass selected from the group consisting of a borosilicate glass, a glass ceramic, and an alkali silicate glass, and/or wherein the second glass is a glass selected from the group consisting of a soda-lime glass, a waterglass, and an alkali silicate glass.

8. The method as claimed in claim 1, further comprising applying a vacuum to the preform.

9. The method as claimed in claim 1, wherein the step of providing the preform comprises:
providing a flat preform;
producing an angular or ovaloid glass tube made of the first glass;
sealing one end of the tube by fusing the tube; and
introducing the second glass into the glass tube at an end opposite the sealed one end.

10. The method as claimed in claim 1, wherein the step of redrawing comprises connecting an upper end of the preform to a vacuum generating device.

11. The method as claimed in claim 9, wherein the glass tube is produced by a laser-based reshaping process which comprises hot-forming a sheet glass made of the first glass.

12. The method as claimed in claim 1, wherein, subsequent to the redrawing step, the method further comprises applying a coating to the glass article on one or both sides thereof.

13. The method as claimed in claim 12, wherein the coating is selected from the group consisting of a scratch resistance coating, a sapphire glass coating, an easy-to-clean coating, an anti-fingerprint coating, an anti-glare coating, an anti-reflective coating, an anti-bacterial coating, and combinations thereof.

14. The method as claimed in claim 1, further comprising, subsequent to the redrawing step, the method further comprises the step of thermally and/or chemically tempered the glass article.

15. The method as claimed in claim 1, wherein the redrawing step comprises reshaping the preform into a sheet glass having a thickness of <3 mm.

16. The method as claimed in claim 1, wherein the first glass has a coefficient of thermal expansion in a range from −0.1*10⁻⁶/K to 12*10⁻⁶/K and/or wherein the second glass has a coefficient of thermal expansion in a range from 0*10⁻⁶/K to 12.1*10⁻⁶/K.

17. The method as claimed in claim 1, wherein the thermal expansion coefficients of the second and first glasses have a ratio (r_{α}) that is greater than 1, and wherein the ratio has an absolute value of less than 125.

18. The method as claimed in claim 1, wherein the thermal expansion coefficients between the second glass and the first glass have a difference (Δ_{α}) that is 0.1 to 12*10⁻⁶/K.

19. The method as claimed in claim 1, wherein the step of providing the preform further comprises providing a third glass in the form of a different glass tube having a rectangular cross-sectional shape and wherein the different glass tube is disposed inside the glass tube, and wherein the second glass is disposed inside the different glass tube.

20. A glass laminate with increased strength, comprising:
a layer composite with at least three layers made of two different glasses,
wherein the at least three layers are connected to each other over an entire surface area and in a non-positive manner, the layer composite having a compressive stress zone in regions close to a surface of the layer composite and by a tensile stress zone in an inner region of the layer composite,
wherein the layer composite has outer layers made of a first glass and an inner layer disposed between the outer layers that is made of a second glass,
wherein the first glass has a first coefficient of thermal expansion and the second glass has a second coefficient of thermal expansion,
wherein the first coefficient of thermal expansion is smaller than the second coefficient of thermal expansion, and
wherein the compressive stress zone is thermally stable.

21. A glass laminate with increased strength, comprising:
a layer composite with at least three layers made of two different glasses,
wherein the at least three layers are connected to each other over an entire surface area and in a non-positive manner, the layer composite having a compressive stress zone in regions close to a surface of the layer composite and by a tensile stress zone in an inner region of the layer composite,
wherein the layer composite has outer layers that are made of a first glass and an inner layer that is disposed between the outer layers that is made of a second glass,
wherein the first glass has a first coefficient of thermal expansion and the second glass has a second coefficient of thermal expansion,
wherein the first coefficient of thermal expansion is smaller than the second coefficient of thermal expansion, wherein, in a viscosity range from 10⁴ to 10⁵ dPa·s, the first glass and/or the second glass exhibits a crystallization rate of >0.5 μm/min, and
wherein the compressive stress zone is thermally stable.

22. A glass laminate with increased strength, comprising:
a layer composite with at least five layers made of three different glasses, wherein the at least five layers are connected to each other over an entire surface area and in a non-positive manner,
wherein the layer composite has the outer layers that are made of a first glass, an innermost layer that is made of a second glass, a layer made of a third glass disposed between each of the outer layers and the innermost layer,
wherein the layer composite has a compressive stress zone in regions of the layer composite close to a surface of the layer composite and by a tensile stress zone in an inner region of the layer composite,
wherein the outer layers are made of a first glass, the layer that is disposed between the outer layers and the inner most layer is made of a second glass,
wherein the first glass has a first coefficient of thermal expansion and the second glass has a second coefficient of thermal expansion,
wherein the first coefficient of thermal expansion is smaller than the second coefficient of thermal expansion, and
wherein the compressive stress zone is thermally stable.

23. The glass laminate as claimed in claim 20, comprising a compressive stress of not more than 800 MPa.

24. The glass laminate as claimed in claim 20, wherein the first glass contains alkali ions.

25. The glass laminate as claimed in claim 20, comprising a ratio of layer thicknesses of the first and second glasses of 3:2.

26. The glass laminate as claimed in claim 22, wherein the third glass has a third coefficient of thermal expansion that is smaller than the second coefficient of thermal expansion and greater than the first coefficient of thermal expansion.
